(19) United States
(12) Patent Application Publication
(10) Pub. No.: US 2004/0028953 A1
(43) Pub. Date: Feb. 12, 2004

(54) Laminated glazing which reflects solar rays and heat rays

(75) Inventor: Franz Kraemling, Aachen (DE)

Correspondence Address: PENNIE & EDMONDS LLP, 1667 K Street, N.W., Washington, DC, 20006, US

(73) Assignee: Saint-Gobain Vitrage

(21) Appl. No.: 10/632,789

(22) Filed: Aug. 4, 2003

Related U.S. Application Data
(63) Continuation of application No. 09/594,262, filed on Jun. 15, 2000, now abandoned.

(30) Foreign Application Priority Data
Jun. 17, 1999 (DE) DE 199 27 683.8

(51) Int. Cl. B32B 9/00

(52) U.S. Cl. 428/698; 428/423.7; 428/701; 428/697; 428/336

(57) ABSTRACT

The present invention relates to glazing made of transparent laminated glass of at least two glass panes united by a transparent intercalating sheet of the thermoplastic type and an antisun coat which essentially reflects rays outside the visible spectrum of the solar rays, in particular infrared rays. The laminated glazing is characterized in that it is equipped, on the surface facing the driving compartment, with a transparent coat which essentially reflects heat rays, of the low-emissive type. Besides its antisun function, it also has an insulating function.

The present invention relates to laminated glazing which has the characteristics of the preamble of claim 1.

Laminated glazing having these characteristics has been known for a long time and is used in many ways and in many applications, mainly in motor vehicles, but also in buildings as safety glazing or antisun glazing. During the use of laminated glazing with a coat which reflects a certain spectrum of solar rays, it is necessary for this coat to be protected inside the lamination, since the antisun coats manufactured in series at the present time are not resistant to bad weather or to mechanical attack.

Particularly for motor vehicles having a large surface area of glass, the heating inside the driving compartments is reduced by using laminated glass panes which have an antisun function. The passengers' comfort is thus increased and, in addition, savings can be made in the energy costs, weight and manufacturing costs: the ventilation and air conditioning units usually used can be dimensioned so as to be of smaller power. Besides the use provided for by law of laminated glass panes as windscreens, laminated glazing is used more and more frequently for the side glass panes, the rear windows and sunroofs. In these cases, this glazing can be equipped with a coat which mainly reflects the rays outside the visible spectrum of solar rays, in particular the infrared rays. Using antisun laminated glass panes effectively prevents excessive heating of the interior of the driving compartments in a quite satisfactory manner, even when the motor vehicle has a large surface area of glass. However, most people consider that large surface areas of glass give an unpleasant cold sensation, on account of their heat absorption when the external temperatures are lower than the internal temperatures. This affects the passengers well-being.

The aim of the invention is thus to improve laminated glazing with antisun properties, such that the heat absorption of a large surface area of glass is greatly reduced in the case of low external temperatures. The aim is thus to provide laminated glazing which, besides its antisun function, also has a heat-insulating function, without it being necessary to use multiple glass panels of the insulating glazing type.

This aim is achieved according to the invention by the subject of claim 1 and the claims which follow.

The laminated glazing according to the invention is equipped, on its surface facing into the driving compartment, with a transparent coat which mainly reflects heat rays and which is mechanically strong. Coats of this type are also known as Low-E (low-emissive) coats since they have a low emissivity, of about 0.1 to 0.25, with a light transmission of 55% to 85% (wavelength from 380 nm to 780 nm). An emissivity of between 0.1 and 0.25 means that between 90% and 75% of the radiation with wavelengths in the range greater than 1100 nm is reflected by the coat. Without a coat of this type, this heat radiation, which originates from the radiation re-emitted for example by the internal surfaces in the vehicle or from a person's body radiation, would be absorbed by the glazing and discharged to the outside by convection via the relative wind while the vehicle is in motion. In this case, the glazing acts as a heat well, and, for a person who finds himself in its field of action, it produces an impression of a cold-radiating body.

Throughout the present text, the term “coat” means a thin (interferential) coat or a stack of thin coats.

The laminated glazing according to the invention is also characterized by a two-fold selectivity for different wavelengths originating from different directions of radiations. On the one hand, the fractions of solar rays coming from the exterior which have a wavelength of greater than 780 nm are mostly reflected. On the other hand, thermal infrared radiation with wavelengths of greater than 1100 nm, which is re-emitted by the interior on the glazing, is also reflected.

The characteristics of the dependent claims 2 to 14 indicate the advantageous improvements of this object.

In one embodiment of the laminated glazing according to the invention, the coat which reflects the heat rays is based, for example, on fluorine-doped tin oxide. Coats of this type are applied by pyrolysis during the manufacture of the flat glass, immediately after the process of floating directly on the glass while it is still hot. Various processes are known, in which pulverulent, liquid or gaseous mixtures of compounds (of the metal halide or organometallic type) are sputtered onto the float glass plate. The fluorine-doped tin oxide forms on the glass as the product of the thermal decomposition of these compounds. Coats of this type can be manufactured industrially in large amounts at an advantageous price. Glazing equipped with them can furthermore be toughened and rendered convex in the subsequent steps of the process. Coats of this type applied by pyrolysis can also be placed on clear glass surfaces without any risk of degradation, since they are highly resistant to mechanical wear, in particular to scratching.

However, other coat systems applied, for example, by sputtering can also have a mechanical strength which is sufficient for the desired use, for example when they incorporate a hard silicon nitride coat as an overcoat.

The term “coat” should be understood as meaning the low-emissive coat optionally combined with at least one undercoat and/or at least one overcoat. These coats can have an optical role, a role of protection against the migration of alkalis from the glass for the undercoat, or a role of mechanical/chemical protection for the overcoat. The undercoat and/or the overcoat can be made, for example, of a silicon derivative such as SiO₂, SiOC, SiON or Si₃N₄ and can also be deposited on the glass on the float line by pyrolysis techniques. One stack of coats which is preferred is thus the stack: glass/SiOC/SnO₂:F. Needless to say, the fluorine-doped tin oxide can be replaced with other doped oxides, or a doped tin oxide can be replaced with another element. This may be ITO (tin-doped indium oxide) or doped zinc oxide.

As stated above, low-emissive coats deposited by cathodic sputtering and protected by at least one overcoat can thus be selected. These may be doped oxide coats or metal coats made of silver, for example. For further details, reference may be made to patents EP-646 196 and FR-2 701 474, for example.

The antisun coat on the laminated glazing according to the invention consists of at least one thin transparent metallic functional coat, which is incorporated between at least one coat of dielectric of metal oxide or silicon nitride type each time. Silver has become established as the metal for the functional coat, since it has relatively little action on colours and selectively reflects the infrared radiation located outside the visible range of solar radiation. The purpose of the oxide coats associated with it is to improve, by means of their refractive index, the optical properties of the glass onto which they are applied and to protect the metallic functional coat from oxidation.

Antisun coats of this type, which can be manufactured by the reactive sputtering process, for example, are used extensively in glazing in buildings, in addition to their existing use in motor vehicles. In most cases, coat systems comprising two functional sliver coats of different thicknesses are used, since their yield and the reflection of the infrared radiation located outside the visible range relative to the transmission of the visible radiation are greater. This therefore gives stacks of the type: dielectric(s)/Ag/dielectric(s)/Ag/dielectric(s), in which each of the dielectrics can be one or more coats of metal oxide of the type SnO₂, ZnO, Nb₂O₅, TiO₂, Ta₂O₆ or SiO₂ or of nitride of the type AlN and/or Si₃N₄. In addition, over and/or under each of the silver coats there may be thin coats of an optionally partially oxidized metal, which are intended to serve as nucleation coats or sacrificial coats. They may be made of Sn, Zn, Ti, Ni, Cr. NiCr, Nb, etc. For further details, reference may be made to patents EP-638 528, EP-844 219 and EP-847 965, for example.

The respective position of the two types of coat used in the invention (low-emissive coat on the one hand, and antisun coat on the other hand) in the laminated glazing is important. Conventionally, the glass faces are numbered starting with the outer face of the glass facing towards the outside.

The antisun coat can be placed on the inner face of the outer glass (face 2), or optionally on the outer face of the inner glass (face 3). A third possibility consists in replacing the intercalating thermoplastic sheet of PVB or EVA type with a stack of two thermoplastic sheets of PVB or EVA type between which is placed a sheet of polymer of the polyethylene terephthalate (PET) type, one of the faces of which is fitted with a stack of infrared-reflecting coats. The PVB sheets are usually about 0.38 mm in thickness, while the PET sheet is preferably about 60 μm in thickness. Other properties of the laminated glazing can be influenced by the thickness of the various sheets. Thus, slightly thicker PVB sheets give better sound insulation, increased resistance of the laminated glazing to attack and also greater protection against UV radiation (UV protection). For examples of this type of structure, reference may be made in particular to patents EP-724 955, EP-758 583, WO 98/00808 and EP-99/403146.6 filed on Dec. 15, 1999. As regards the low-emissive coat, it is preferably on face 4 of the glazing, which is the face oriented towards the inside of the inner glass.

In another advantageous improvement of the laminated glazing according to the invention, the glass panes which are located before the antisun coat relative to the sun are essentially or even totally transparent. When the antisun coat is placed on face 2, the outer glass preferably consists of alkali-lime glass, which is low in iron oxide. It is thus not tinted. When a sheet of PET is located inside the laminate and is equipped with an antisun coat, it is preferable that the outer glass and the sheets which are located before the antisun coat should be essentially or even totally transparent. By using totally transparent sheets before the antisun coat, the capacity of the antisun coat to reflect infrared can be considerably increased, since there is little or no absorption of solar radiation.

Visual comfort may be desired, for example for the side window panes and the rear windows, in the manner referred to as “dark-tall” glazing or for sunroofs of large surface area. In this case, a glass or sheet, which is located behind the antisun coat when looking in the direction from which the solar radiation arrives, is preferably chosen to be tinted in the bulk or printed. On account of the absorption of the unreflected solar radiation, the laminated glazing does, admittedly, become heated overall, by virtue of the Low-E coat on the face oriented towards the inside (face 4). However, the heating of the interior by heat emission may be considerably reduced compared with laminated glazing without a Low-E coat on account of the reduction in the emissivity. The heating of the interior is thus reduced by limiting the secondary radiation, in contrast with laminated glazing without a Low-E coat.

The two glass panes of the laminate consist of float glass generally of between 1 mm and 4 mm in thickness. A glass thickness of 2.1 mm represents a good compromise between stability and weight. If the laminated glazing needs to be rendered convex, the two glass panes are, in a known manner, rendered convex in pairs by gravity and then combined together by the thermoplastic sheet under the action of pressure and/or heat. In this convexing process, the two glass panes can also have different thicknesses. Before laminating them, it goes without saying that the coat which reflects heat rays and the antisun coat should be deposited. When high flexural strengths are desired, it is also possible to use partially or fully toughened glass panes. The two glass panes are then (partially) toughened and rendered convex separately. In this case, the two glass panes need to have similar thicknesses, in order for their lines of curvature to have the most similar shape possible.

The antisun coat can also be used for other applications (in conjunction with its heat function): as a glass-heating device or as a receiving antenna for electromagnetic rays. The coat which reflects infrared rays is in fact electrically conductive. It simply suffices to equip it with a power supply. If necessary, the shape of the coat can be adapted according to the application envisaged. For example, it can be in the shape of a slot antenna.

Other details and advantages of the subject of the invention will emerge from the non-limiting example which follows, of laminated glazing used in a motor vehicle sunroof.

### EXAMPLE

The laminated glazing according to the invention, intended for mounting in a vehicle roof, consists (considered from the outside inwards):

of an outer glass 3 mm thick,

a transparent antisun coat (face 2),

a totally transparent intercalating sheet made of polyvinyl butyral, which is 0.76 mm thick,

another intercalating sheet 038 mm thick, made of tinted polyvinyl butyral,

an inner glass 3 mm thick, and

a mechanically strong, transparent, heat-protecting coat (face 4) of the Low-E coat type.

The two sheets of polyvinyl butyral form a thermoplastic adhesive coat for the two glass panes. The lamination is carried out with the aid of a process that is common in the glass industry, using pressure and/or heat. The sheet next to the outer glass has a high thickness and thus protects the other sheet of PVB, which is tinted, against UV rays which might destroy its pigments.

The antisun coat, which essentially reflects the rays located outside the visible spectrum of solar rays, thus in particular infrared rays, is deposited by magnetic-field-assisted cathodic sputtering, in a known manner. This coat comprises a stack having two functional silver coats of different thicknesses, which are each surrounded by coats of dielectric of metal oxide and/or metal nitride or silicon nitride type. The infrared reflection is already at 50% above a wavelength of 900 nm and rises to more than 80% for radiation of longer wavelength. The transmission in the visible region is, for example, about 78% for light with a wavelength of 580 nm.

The inner glass is equipped on its surface facing inwards (face 4) with a Low-E coat of fluorine-doped SnO₂. This Low-E coat can be manufactured, for example, by pyrolysis directly on the ribbon of float glass, by sputtering a pulverulent organic tin compound and a pulverulent fluorine compound, which are suspended in a stream of carrier gas, on the glass while it is still hot, at a temperature of from 400° C. to 650° C. This coat has a Low-E factor of 0.15, which means that 85% of the infrared radiation of long wavelength is reflected. It can also be deposited by gas-phase pyrolysis (chemical vapour deposition, CVD) and can preferably be deposited on a precoat made of SiOC deposited by CVD.

It goes without saying that the antisun and heat-protecting coats should be deposited before laminating the two glass panes.

The light transmission of the laminated glass in its assembly is equal to 31%, 69% of the visible radiation is reflected or, depending on the case, absorbed by the heat coat, the Low-E coat and the sheet of tinted PVB.

1. Transparent laminated glazing comprising at least two glass panes united by a thermoplastic intercalating sheet and an antisun coat which essentially reflects the rays outside the visible spectrum of the solar radiation, in particular infrared rays, characterized in that the laminated glazing also comprises a transparent coat which essentially reflects heat rays, of the low-emissive coat type, which is placed more towards the interior than the antisun coat.

2. Laminated glazing according to claim 1, characterized in that the coat which reflects heat rays is a coat of doped metal oxide, in particular of fluorine-doped tin oxide and is preferably deposited by pyrolysis.

3. Laminated glazing according to claim 1 or 2, characterized in that the coat which reflects heat rays is equipped with at least one undercoat and/or at least one overcoat, and in particular with a mechanically strong protective coat.

4. Laminated glazing according to one of the preceding claims, characterized in that the antisun coat consists of a stack of coats comprising at least one metallic coat incorporated between coats of dielectric of the metal oxide or nitride type such as AlN or Si₃N₄, in particular at least one silver-based coat.

5. Laminated glazing according to claim 4, characterized in that the antisun coat consists of a stack of coats comprising two sliver coats of different thicknesses.

6. Laminated glazing according to one of the preceding claims, characterized in that the antisun coat is applied to the inner face of the outer glass, on face 2, or to the outer face of the inner glass, on face 3.

7. Laminated glazing according to one of claims 1 to 5, characterized in that the intercalating sheet is equipped with an antisun coat.

8. Laminated glazing according to claim 7, characterized in that the intercalating sheet comprises at least two sheets of thermoplastic polymer of the PVB type and, between these, a sheet of polymer of the PET type equipped with the antisun coat.

9. Laminated glazing according to claim 8, characterized in that the sheet equipped with the antisun coat is between 25 μm and 90 μm in thickness and preferably about 60 μm in thickness.

10. Laminated glazing according to one of the preceding claims, characterized in that the coat which reflects heat rays is placed on the inner face of the inner glass, on face 4.

11. Laminated glazing according to any one of the preceding claims, characterized in that, relative to the exterior, the coats/sheets/glass panes of the laminated glazing before the antisun coat are essentially or totally transparent.

12. Laminated glazing according to any one of the preceding claims, characterized in that, relative to the exterior, behind the antisun coat, at least one of the coats/sheets/glass panes of the glazing is tinted or printed.

13. Laminated glazing according to claim 12, characterized in that the intercalating sheet comprises several thermoplastic sheets, one of which is transparent and one of which is tinted in the bulk or printed, the tinted sheet being placed more towards the interior than the transparent sheet.

14. Laminated glazing according to any one of the preceding claims, characterized in that the two glass panes are each between 1 mm and 4 mm in thickness and preferably about 2.1 mm in thickness.

15. Laminated glazing according to any one of the preceding claims, characterized in that the two glass panes are at least partially toughened and/or rendered convex.

16. Laminated glazing according to any one of the preceding claims, characterized in that the antisun coat also serves as a heating coat.

17. Laminated glazing according to any one of the preceding claims, characterized in that the antisun coat also serves as a receiving antenna for electromagnetic radiation.

18. Application of the glazing according to one of the preceding claims, as a windscreen, a side window pane, a rear window or a sunroof for vehicles such as motor cars.
